(19) United States
(12) Patent Application Publication
(10) Pub. No.: US 2011/0063224 A1
(43) Pub. Date: Mar. 17, 2011

(54) SYSTEM AND METHOD FOR REMOTE, VIRTUAL ON SCREEN INPUT

(76) Inventors: Frederic VEXO, Bussigny-pres-Lausanne (CH); Nicolas Chauvin, Chexbres (CH); Pascal Eichenberger, Blonay (CH)

(21) Appl. No.: 12/840,320

(22) Filed: Jul. 21, 2010

Related U.S. Application Data
(60) Provisional application No. 61/227,485, filed on Jul. 22, 2009.

(51) Int. Cl. G06F 3/02

(52) U.S. Cl. 345/168

(57) ABSTRACT

A system, apparatus, and method of remote, virtual on screen data input includes a peripheral data input device (PDID) made up of a proximity sensor and data communications means. The proximity sensor is adapted to dynamically recognize the movement of a target in the proximity of the peripheral device. The data connection device is adapted to transmit signals from the proximity sensor to a processor communicatively coupled to the remote display. The processor constructs a representation of input fields on the display, and, when detected, overlays a real-time, virtual representation of the target over the representation of the input fields.

### CROSS REFERENCE TO RELATED APPLICATIONS

This application claims the benefit of U.S. Provisional Application No. 61/227,485, filed Jul. 22, 2009, the content of which is incorporated by reference thereto and relied upon.

### COPYRIGHT & LEGAL NOTICE

A portion of the disclosure of this patent document contains material which may be subject to copyright protection. The copyright owner has no objection to the facsimile reproduction by anyone of the patent document or the patent disclosure as it appears in the Patent and Trademark Office patent file or records, but otherwise reserves all copyright rights whatsoever. Further, no references to third party patents, to articles or to manufacturer model numbers made herein is to be construed as an admission that the present invention is not entitled to antedate such material by virtue of prior invention.

### BACKGROUND OF THE INVENTION

This invention relates to input devices and methods, in particular, systems and methods for inputting data in and transmitting commands for Multimedia Services, Applications and Devices.

It is known to use input devices such as a mouse and a keyboard to input data into a personal computer (PC) or multimedia system (such as a television, Set-top box, Game console, or other computer processing device), connected via data buses, data interfaces, wireless RF, infrared, “BLUETOOTH”™, Wi-Fi™, via a data hub to a PC, to name a few.

Virtual keyboards, integrated on the devices themselves, are also known which allow inputs without actually having to touch the device. Further, user input while wearing data gloves is known.

Monotouch and multitouch keyboards or input devices are known, and allow, as the case may be, single or multiple inputs from a user. In other words, monotouch interfaces read one input at a time, while multitouch can read/sense two or more inputs at a time.

Recently, now, multi-touch technologies are emerging for application in mobile phone technology. Companies such as Stantum S.A. in France, STMicroelectronics in Switzerland, Cypress Semiconductor in the US, Avago Technologies in the US and Synaptics Inc. in the US are developing multi-touch technologies in response to mobile phone customer demands. Examples of technologies used by such multitouch input devices include resistive, inductive, thermal, capacitive or electromagnetic touch and/or proximity sensing to sense or image the presence of an object within its detection field.

The I-PHONE® by Apple, Inc, of Cupertino, Calif., provides a display which responds to a proximity sensor which deactivates the display and touchscreen when the device is brought near the face during a call. This is done to save battery power and to prevent inadvertent inputs from the user's face and ears.

Companies like Atracsys in Switzerland are developing touch-less interfaces where one or multiple users can interact with the device screen with multitouch gesture nearby the display but without actually touching it.

Other known techniques exist such as via capacitive sensing techniques and other electromagnetic techniques in which a user's body need not actually touch the multi-touch sensing device, but rather need only be placed in sufficient proximity to the multi-touch sensing device so as to be interpreted as a touch input. For example, SIDESIGHT™, by Microsoft Research of Redmond, Wash., allows manipulation of images on a small screened multitouch mobile device by finger movements to the sides of the device, without touching the unit. See article “SideSight: Multi-“touch” Interaction Around Small Devices, by Alex Butler et al, with a claimed publication date of Oct. 19, 2008, the content of which is incorporated herein by reference thereto. Nevertheless, such technology is looking for a practical application, and otherwise does not appear to have been implemented in a product in any significant way.

Known prior art devices integrate the touch screen in the screen of the primary display device itself. This necessitates that the user be physically proximate the primary display device. Such proximity can be undesirable where the user's hands or fingers obstruct the view of the display device to an audience. Further, larger display devices may give off unwanted electromagnetic radiation. In such a case, the user may not wish to be proximate such a device when interfacing therewith. Still further, the user may wish to assume a comfortable body position which is not necessarily conducive to interaction with a large display device. Using prior art devices, it is likely that the user would not be able to interface with such a device in his chosen position of personal comfort. Further still, when multiple users are viewing the same display device, it is convenient for a user-presenter to be able to control the presentation remotely from the display device.

What is needed therefore is an apparatus, system and method offering to the user a way to remotely touch a screen using a remote input device which is portable and separate from the display device. What is needed is an apparatus, system and method which provides the user with the ability to input text as he or she would have performed directly on a display having an integrated multitouch surface thereon without physically touching the display. In addition, what is needed is an apparatus, system and method which allows the user to observe a virtual keyboard and a virtual representation of his or her fingers positioned at the correct location relative to the virtual keyboard on the display device.

### SUMMARY OF THE INVENTION

In accordance with an embodiment of the present invention, a peripheral data input device (PDID or peripheral device) for use in remote, virtual on screen data input includes a proximity sensor and data communications means. The proximity sensor is adapted to dynamically recognize the movement of a target in the proximity of the peripheral device. The data connection device is adapted to transmit signals from the proximity sensor to a processor communicatively coupled to a remote display. The processor constructs a representation of input fields on the display, and, when detected, overlays a real-time, virtual representation of the target over the representation of the input fields.

In another embodiment, a system and method are provided which include (a) the PDID with a proximity sensing subsystem (PSS), a transmitter and interface device adapted to connect to, communicate with and transmit data and commands to a processor typically of a PC or multimedia system (such as a television, set-top box, or game console); and (b) instructions executable on the processor for receiving data inputs from the PDID, the instructions, when data is transmitted from the proximity sensing subsystem, (i) displaying a virtual representation of an input field on a remote display along with a virtual representation of the target, in a typical case, a finger of the user, positioned on the display relative to the representation of the input field in an orientation which recreates, in 2D plan view, the real world relative position of the target with an input field on the real world PDID, and (ii) receiving data inputs from the PDID and processing such in an manner appropriate to the class of data transmitted, whether representative of an alphanumeric, word, or command input.

Although not necessary to gain the benefits of the invention, various embodiments of the present invention can be used both with display devices having integrated touch screens, as well as with devices that do not include a touch screen.

An object of the invention is to give a user a touch screen experience on a display device that does not necessarily include an integrated touch screen. This elimination of the need for touch screen hardware in the display screen itself either significantly reduces hardware costs compared to a large screen display that integrates touch screen sensors or increases user choice in selecting a display device and peripheral combination suitable to his needs.

Another object of the invention is to allow a user to input data into a virtual keyboard remotely from a displayed virtual representation of the keyboard. In this manner, a user is provided with the user experience of using a distant (relative to the user) touch screen display device without having to physically touch the display device.

Another object of the invention is to permit a user to be able to input data without having to glance down at a remote input device but rather enabling the user to maintain his or her visual focus on the display device.

Another object of the invention is to permit a user more comfort and flexibility in interacting with a PC or multimedia device, such as a multimedia player.

Another object of the invention is to permit the user to gesticulate to an audience with his hands or arms, for example, overlaid on a presentation screen which is physically distant from the user, but nonetheless the focus of the audience's attention.

Another object of the invention is, through the use of a virtual keyboard, to avoid the need of physically printing a keyboard layout on the peripheral device of the invention in the one of several accepted standards generally based on language (US, French, German, Spanish, number pad keys) as such layouts are region, language, or function dependent, thereby avoiding the logistical complexity of having to manufacture, stock and deliver printed keyboards specific to a user's usually geographically dependent needs.

### BRIEF DESCRIPTION OF THE DRAWINGS

FIG. 1 is a perspective view of an embodiment of a system of the invention.

FIG. 2 is a top view of a virtual keyboard with the target overlaid in transparent mode.

FIG. 3 is a top view of a second virtual keyboard with targets, in this case, thumbs, overlaid in transparent mode.

FIG. 4 is a schematic diagram of the PDID used in an embodiment of a system and method of the invention.

FIG. 5 is a block diagram of the PDID of an embodiment of the invention

FIG. 6 is a schematic side view of a touch pad module with the proximity hovering feature in accordance with an embodiment of the invention.

FIG. 7A is a schematic view showing, in the upper portion thereof, a graphical representation of the detected relative position of a hovering finger, the hovering finger shown relative to the input surface in the lower portion thereof.

FIG. 7B is a schematic view showing, in the upper portion thereof, a graphical representation of the detected relative position of landed fingers, the landed fingers shown relative to the input surface in the lower portion thereof.

FIG. 8 is a table showing representative classifications of inputs.

FIG. 9 is a flow chart of a first method of the invention.

FIG. 10 is a schematic view of the triangulation step in accordance with a the method of the invention.

FIG. 11 is a schematic view of a hybrid touchpad module in accordance with an embodiment of the invention.

FIG. 12 is a flow chart of a second alternative method of the invention.

FIG. 13 is a perspective view of an array or cluster of keys having integrated in each key an optical proximity detector.

Those skilled in the art will appreciate that elements in the figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended to distinguish between similar elements and not necessarily to describe a sequential or chronological order. Moreover, relative terms like ‘front’, ‘back’, ‘top’ and ‘bottom’, and the like in the description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT(S)

The following description is not intended to limit the scope of the invention in any way as they are exemplary in nature and serve to describe the best mode of the invention known the inventors as of the filing date hereof. Consequently, changes may be made in the arrangement and/or function of any of the elements described in the disclosed exemplary embodiments without departing from the spirit and scope of the invention.

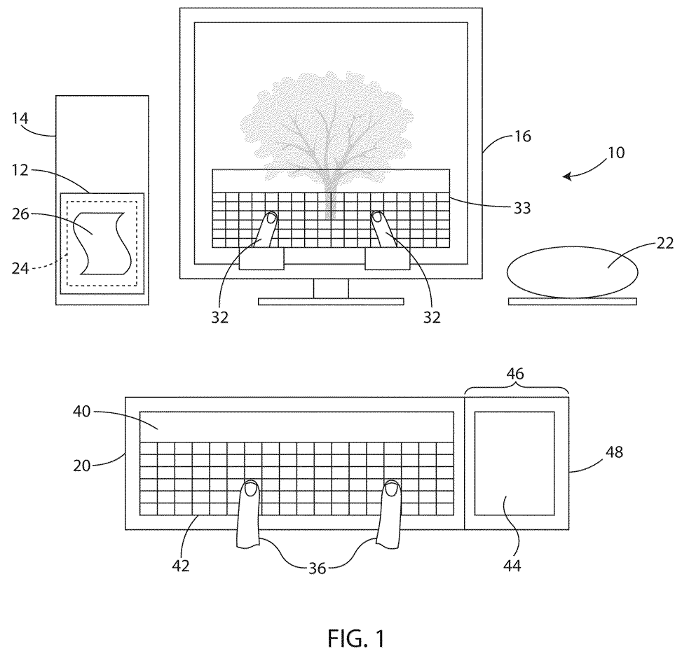

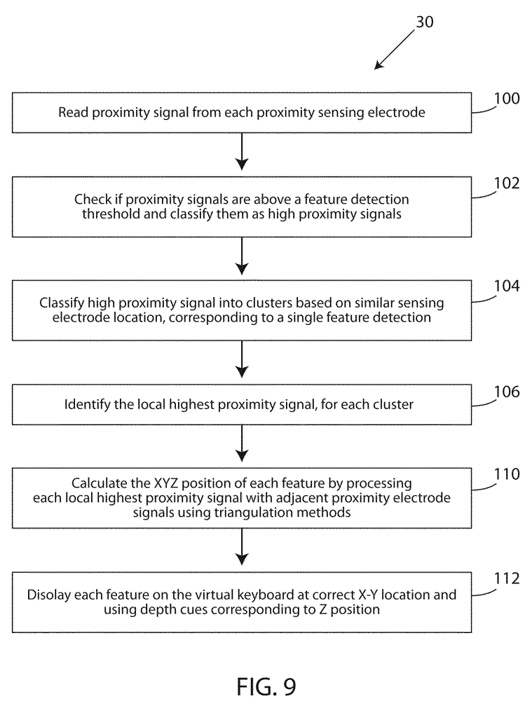

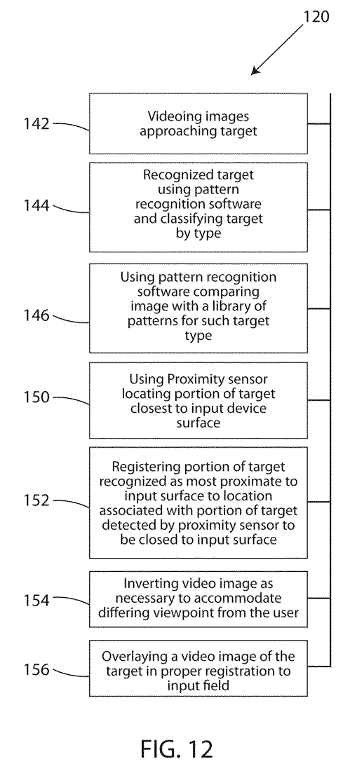

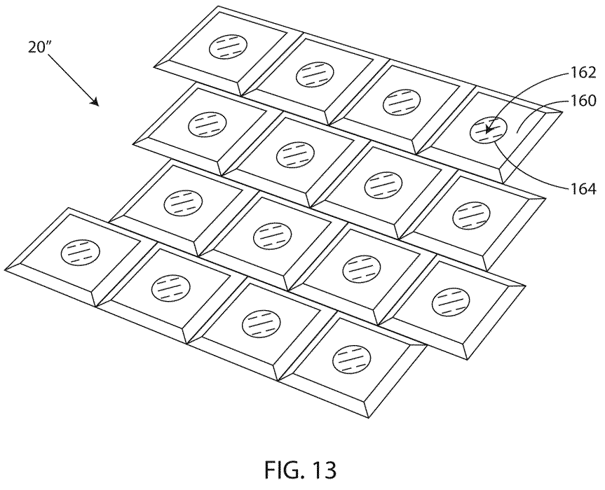

Suitable enabling technology for aspects of this invention, namely, underlying hardware components suitable for some of the features described herein, is described in U.S. Pat. No. 7,653,883, and U.S. Provisional Application No. 61/314,639, entitled SYSTEM AND METHOD FOR CAPTURING HAND ANNOTATIONS, filed on 17 Mar. 2010, the contents of which are incorporated herein by reference thereto. Referring to FIG. 1, a system 10 of the invention includes an interconnected computer processor 12 (housed, for example, in a PC, a set-top box or multimedia device 14), a display 16 (e.g., a TV, a computer screen, a projector, etc.), an input device 20, and a wireless hub 22. The computer processor 12 and operating system (OS) 24 execute instructions 26 for carrying out the method 30 of the invention (described in association with FIGS. 9 and 12). The instructions 26 are executed on the OS 24 to receive and process data received from such PDID 20 in order to display representation(s) 32 of the target(s) 36 and at least a representation 33 of the input field 40 of the PDID 20 on the display device 16 so as to mimic the relative location and input functions performed by a user 34 on the PDID 20. In this manner, the invention provides remote, virtual on-screen data input.

Optionally, as shown in the figure, the multi-touch input surface 44 of the PDID 20 is integrated onto a housing 46 which is separable from a principle input device 38 permitting keying.

The target 36, mentioned above, although typically a user's finger or fingers, can also be various other things such as, but not limited to, a user's hand or hands, arm or arms, identifiers on gloves, rings, etc., a stylus or styluses, pencil or pencils, pen or pens, and a pointer or pointers.

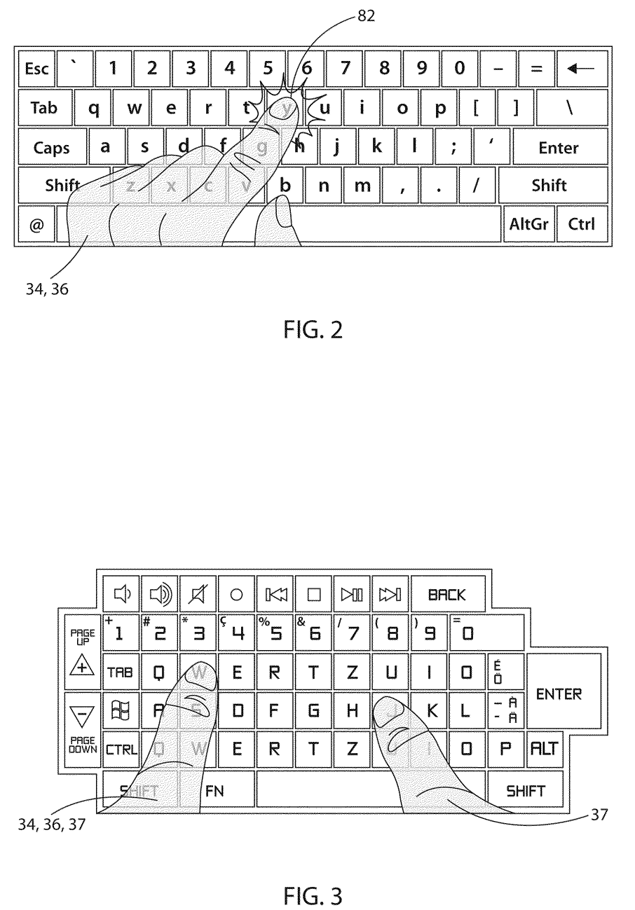

Referring to FIG. 2, preferably, the representation of the target 36 and the input surface 40 for display in a window of the display 16 are transparent (i.e., displayed in transparent mode), permitting viewing of screen content visually underneath the representation of the target or input field.

In one input example, the user 34 types information into the input device 20 in the normal way. In another input example, as shown in FIG. 3, the user enters text naturally with his or her two thumbs 37 while holding the PDID 20, 20′, 20″ in hand. In such an example, both of the user's thumbs 37 are displayed and correctly placed on the virtual representation 32 on the display 16 as the thumbs are hovering over the PDID surface 40, 44.

In one embodiment, the PDID 20, 20′ incorporating functionality of emerging touch data input devices such as those available from Stantum in France, STMicroelectronics in Switzerland, Cypress Semiconductor in the US, Avago Technologies in the US and Synaptics in the US. In one embodiment, the PDID 20 includes a touch surface 40 providing a keyboard input field 42, as well as a touch surface 44 for use on the housing 46 of an auxiliary pointing or number input device 48, at the selection of the user 34. Separate touch surfaces 40 and 44 allow the use of a lesser expensive single touch surface for touch surface 40, through which text inputs may be entered, whereas the more expensive multi-touch surface 44 is minimized, yet can control the modes of operation of the single touch surface 40, by allowing multi-touch inputs to be toggled between key overlays, for example. Optionally, the input device 48 may be readily removable while being in wireless contact with the hub 22 and/or communication device (not shown) integrated in the PDID 20.

It should be noted that other proximity sensors are suitable for use with the invention. Sensors which work by emitting an electromagnetic or electrostatic field, or a beam of electromagnetic radiation (infrared, for instance), and looks for changes in the field or return signal may be used. The types of suitable sensors available include but are not limited to inductive, capacitive, capacitive displacement, eddy-current, magnetic, electromagnetic, photocell, laser rangefinding, sonar, radar, Doppler effect, passive thermal infrared, passive optical, ionizing radiation reflective sensors, reed switch, hall effect, resistive variation, conductive variation, echo (e.g. sound be it ultrasonic or radar), optical pattern recognition technologies and micro air flux change (detections of air current variations between sensors as opposed to macro flux changes). For example, a capacitive or photoelectric sensor might be suitable for a plastic target while an inductive proximity sensor requires a metal target and a Hall Effect sensor a magnetic target.

Optical sensing using, for example, infrared proximity sensing, involves using an optical sensing circuit to pulse light, e.g., infrared light, emitted from an emitter which, should an object such as a user's finger be present in front of or above the emitter (e.g., a laser diode or LED), reflects off of the user's finger and back toward an infrared detector (e.g., a photodiode, a type of photodetector capable of converting light into either current or voltage, depending upon the mode of operation), generally adjacent or concentric with the emitter and configured to detect changes in light intensity. If reflected infrared light is detected, it is assumed that an object is present, proximate the infrared emitter. If not, then it is assumed no object is present. When a threshold of light is detected that corresponds to touch, at distance of 0 mm, then touch is indicated and whatever action that is to be executed upon touch is initiated. In such a case, the touch parameter is a parameter of sufficient proximity, which is typically contact, at which proximity a touch signal indicating touch is sent to the processor 12, thereby allowing traditional keypad use with the benefits of touch pad use. As an example of a suitable infrared proximity sensor, Avago Technology's proximity sensors are reflective, non-contact sensors in a small form factor SMT package that offer detection ranges from near zero to 60 mm with analogue-output. Suitable for use in mobile applications and industrial control systems, their model APDS-9101 is a low cost, integrated reflective sensor incorporating infrared LED and a phototransistor designed to provide object detection and non-contact proximity sensing in the detection range of near 0 mm to 12 mm. The proximity sensors described in U.S. patent application Ser. No. 11/418,832, entitled OPTICAL SLIDER FOR INUT DEVICES, the content of which is incorporated by reference hereto, available from Logitech, Inc. of Fremont, Calif., are also suitable for this purpose. Note that an embodiment of this invention using an infrared sensor is described in more detail in connection with FIG. 13, below.

Capacitive proximity sensing, a preferred means of proximity sensing, takes advantage of the fact of a measurable change in capacitance over a sensor when a target is and is not present within its sensing range. If a change from a nominal or initial state is detected, then it is assumed that a target is present. Another suitable capacitive proximity sensor system for use in the invention is available from Freescale Semiconductor, Inc of Austin, Tex. Freescale's proximity controller model MPR08X controls multiple proximity sensors thereby allowing control of several different applications from one sensor. By multiplexing the electrodes, a single sensor is able to detect at multiple points. For example, proximity capacitive-touch sensors manage multiple configurations of touch pads, sliders, rotary positions and mechanical keys for user interfaces.

In addition, other proximity sensors (e.g., Freescale's model no MC33794) may be used which rely on interruption of an electric field, using a low frequency sine wave with very low harmonic content whose frequency is adjustable by an external resistor. Electromagnetic proximity sensing scans a region around an antenna adjacent the input interface, constantly monitoring electromagnetic field changes in the vicinity of the antenna. A self-diagnostic function detects when there is a field change which corresponds to the presence of an object, e.g., a user's finger, near the antenna. In order to allow more discrete detection, multiple antennae can be used.

Still further, a video camera with a defined focus can be used, in which images seen by the video camera are recognized using pattern recognition technology which itself may use artificial intelligence techniques to classify a sensed object. Here, for proximity detection, neural network technology identifies the pattern of an object, classifying the same as a hand, finger, stylus, pointer or an anomaly, for each sensor. Touch may then be defined as the absence of light detected by the sensor, as a finger covers a camera node entirely. One example of such an embodiment is described in more detail in connection with FIG. 12 below. In such an embodiment, the proximity sensor system may be made up of an array or cluster of cameras and so work much like that of the compound eye of a fly.

Ultrasonic proximity sensing uses technology found in nature and used by bats to identify and avoid proximate objects in flight. Adaptation of the invention to use ultrasonic proximity sensing is considered within the capacity of someone of ordinary skill in the art when using the present disclosure as a guide.

For magnetic sensors, it is contemplated to include the use of a metal ring or a user glove having metal, magnetic, or plastic parts strategically located to optimize the function of the interface with such sensors resulting in advantageous features such as more accuracy in movement detection, etc. Further, some sensors have adjustments of the nominal range of detection or means to report a graduated detection distance. For such detectors, it is contemplated to enable a user to change parameters (through interaction with a user interface on the computer or peripheral) such that the proximity sensing touch interface detects the target sooner, or later, depending on the user's preferences. Such proximity detectors are disclosed in IEC 60947-5-2, published by the International Electrotechnical Commission, the content of which is incorporated by reference thereto.

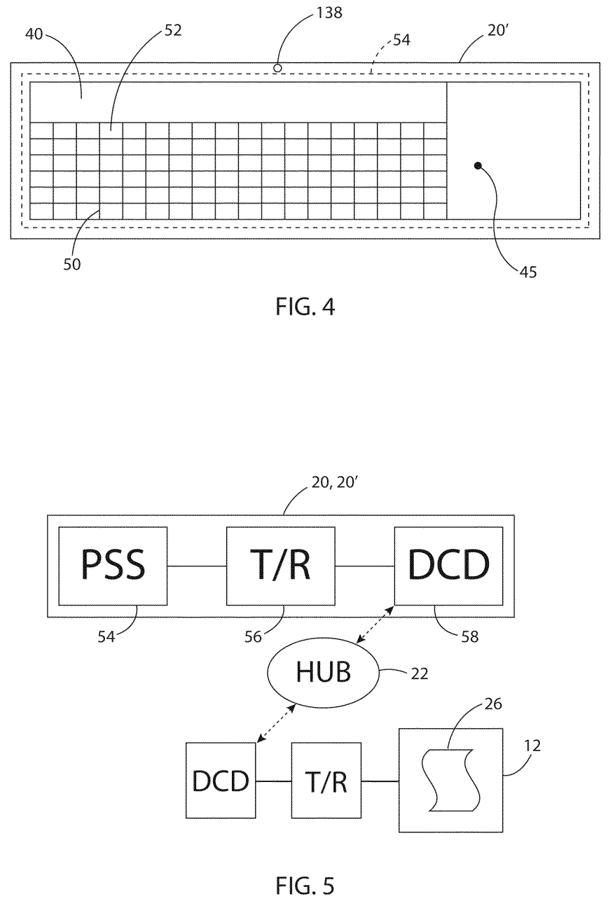

Referring to FIG. 4, a schematic diagram of an alternative PDID 20′ includes a single multi-touch surface 45 used in the invention.

Optionally, a grid 50 of delineations of key input fields or zones 52 can be pre-printed on the touch surface 40 or 45, or the touch surface can be an integrated touch display screen which displays the delineations of the key input fields or zones. The capacitive touch screen 45 is printed so as to define key fields 52 which, if touched within the field, trigger the registration of the corresponding letter, symbol or command selected. In addition to printing, such fields 52 can be defined by displaying the fields on a liquid crystal touch screen.

Referring now to FIG. 5, in one embodiment, the PDID 20, 20′ has a proximity sensing subsystem 54 (PSS), a transceiver (T/R) 56 adapted to transmit and receive encoded data according to a communications protocol via IR, RF, “BLUETOOTH”™, “WiFi”™ through a data connection device (DCD, such as an antenna) 58 for communicating data and command signals to processor 12, preferably via the wireless hub 22 (via, for example, a second data connection device and transceiver). In another embodiment, the PSS 54 is optional, and a system in accordance with an embodiment of the present invention may be based on touch (without proximity sensing). The instructions 26 are executable on the processor 12 for receiving data inputs from a PDID 20, 20′. The instructions 26, when data is transmitted from the proximity sensing subsystem 54, cause the display of a virtual representation 33 of the PDID 20, 20′ (or the input field 42, 44 thereof) on the display device 16 along with a virtual representation 32 of the target 36, positioned on the display relative to a representation of at least the input field of the PDID 20, 20′ in an orientation which recreates, in 2D plan view, the real world relative position of the target 36 with respect to the real world PDID 20, 20′. The instructions 26 then cause the reception of data inputs from the PDID 20, 20′ and processing such in a manner appropriate to the class of data transmitted, whether representative of an input letter, word, or command (e.g., shift or control functions).

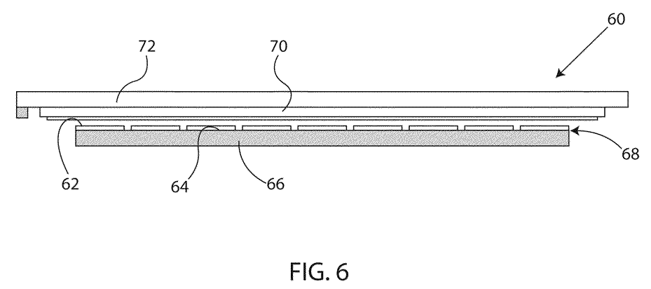

Referring to FIG. 6, in an embodiment, the PDID 20, 20′ includes a touchpad module 60 with added proximity sensing. A suitable multi-touch remote device for use in the touchpad module 60 is based on the “TRUETOUCH”™ touchscreen solution available from Cypress Semiconductor Corp of San Jose, Calif. This device integrates capacitive proximity finger hovering functionality.

In such an embodiment, the touchpad module 60 has proximity sensors 62 integrated on a surface 64 in a tight array or cluster 68. A thin film backlight 70 (thickness approximately 0.3-0.4 mm available from Modilis “FLEXFILM”™ of Finland) is added on top of the array 68 of proximity sensors 62, followed by a glass panel 72 (thickness approximately 0.6-0.8 mm), optionally with paint masking to mark input areas, which seals the assembly in a housing (not shown).

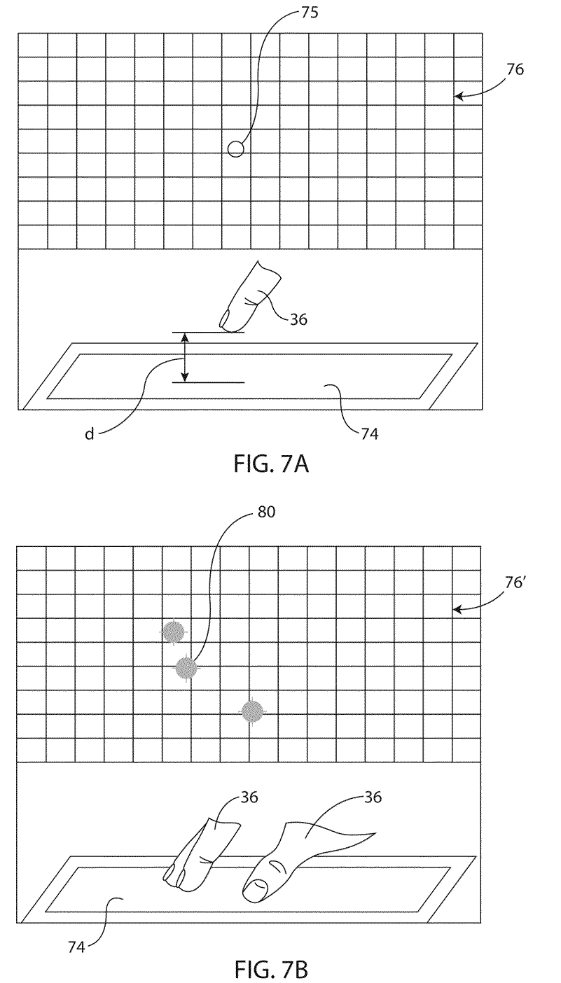

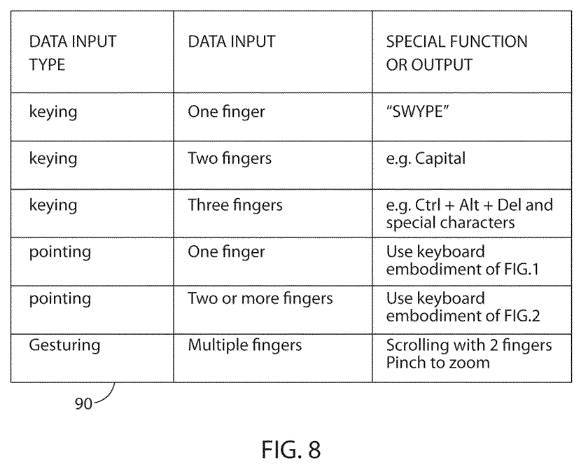

Referring to FIGS. 7A and 7B, in the above embodiment, proximity sensors 62 locate the target 36, in this case a finger, as it approaches the multi-touch surface 74. The circle 75 indicating the relative position of the target 36 on a grid 76 is unfilled when no touch is detected. When proximity has been detected, the circle 75 appears, and its size typically indicates the distance d of the target 36 from the multi-touch surface 74.

In FIG. 7B, when detected targets 36 actually land on the surface 74, the unfilled circles 75 indicating the relative position of the target become filled circles 80. When touch has been detected, typically, the area of contact between the target 36 and the surface 74 is indicated by its actual size or at least relative size with respect to the input surface is maintained.

The processor 12 interprets the touch or hover information as shown in the grids 76, 76′ above the schematics of the approaching or touching action in the figures. From the grid location, the processor 12 is able to read location, determine whether touch has occurred, discern how many targets 36 are involved as well as estimate the distance d from touch interface that target is and, when a touch is indicated (by the filled circles 80), determine how large a surface is being touched.

Where the PDID 20, 20′ includes a multitouch module 60 therein, data input and the visualization thereof may be performed as described in a number of prior art patents. For example, U.S. patent application Ser. No. 11/696,703 entitled ACTIVATING VIRTUAL KEYS OF A TOUCH-SCREEN VIRTUAL KEYBOARD, the contents of which are hereby incorporated by reference hereto, describe in more detail a method of operating a touch screen to activate one of a plurality of virtual keys. A touch location is determined based on location data pertaining to touch input on the touch screen, wherein the touch input is intended to activate one of the plurality of virtual keys. Each of the plurality of virtual keys has a set of at least one key location corresponding to it. For each of the virtual keys, a parameter (such as physical distance) is determined for that virtual key that relates the touch location and the set of at least one key location corresponding to that virtual key. The determined parameters are processed to determine one of the virtual keys. For example, the determined one virtual key may be the virtual key with a key location (or more than one key location, on average) being closest to the touch location. A signal is generated indicating activation of the determined one of the virtual keys. A signal is generated indicating activation of the identified virtual key. Referring again to FIG. 2, the signal can be the highlighting or glowing of that particular key 82.

Referring to FIG. 8, a table 90 showing representative classifications of inputs in accordance with one embodiment of the present invention is provided. Such should be considered as a typical, nonexhaustive example of input classification. Simple, intuitive action on the part of the user is required in order to distinguish between modes of operation of the PDID 20, 20′. A typical example would be where a single target 36 is sensed by the PSS 54, the inputs received from the PDID 20, 20′ are classified as single inputs of letters, numbers or symbols, preferably augmented by “SWYPE” technology (facilitating gesture based input). Where two targets 36 are sensed spaced apart from one another, the inputs received from the PDID 20, 20′ are classified as command or macro inputs. Where two targets 36 in close proximity to one another are sensed, the inputs received are classified as pointing device control inputs. Such pointer inputs execute a pointer subroutine which processes the data received as pointer data inputs, controlling a cursor on the display screen in any known manner. Such convention provides a transparent input mode to the user.

It should be noted that the inputs made to the PDID 20, 20′ can have any meaning defined by any suitable protocol, and may even be combined with inputs to other input devices (e.g. from standard keyboard inputs to eyelid wink detection, for example) to create new more complex meanings.

U.S. patent application Ser. No. 11/696,701 entitled OPERATION OF A COMPUTER WITH A TOUCH-SCREEN INTERFACE, the content of which is incorporated herein by reference thereto, describes use of a touch screen to detect various user inputs which trigger the display of a virtual keyboard. U.S. patent application Ser. No. 10/903,964 entitled GESTURES FOR TOUCH SENSITIVE INPUT DEVICES, the content of which is incorporated herein by reference thereto, describes the detection of gestures for more complex user inputs, which, depending on the gesture, display a selected virtual keyboard. U.S. patent application Ser. No. 11/696,693 entitled VIRTUAL INPUT DEVICE PLACEMENT ON A TOUCH SCREEN USER INTERFACE, the content of which is hereby incorporated by reference hereto, describes the generation of a display on a touch screen of a computer. In the context of this application, the touch screen is analogous to the display of the display device and, using similar hardware and processing steps, can be used to generate the virtual input device display described herein as the virtual representation of the PDID or virtual keyboard.

Referring to FIG. 9, the method 30 of the invention includes the following steps: step 100, reading proximity signal from each proximity sensing electrode; step 102, checking if proximity signals are above a feature detection threshold and classify them as high proximity signals; step 104, classifying high proximity signals into clusters based on corresponding sensing electrode locations which indicate a single feature detection; step 106, identifying the local highest proximity signal, for each cluster; step 110, calculating the XYZ position of each feature by processing each local highest proximity signal with adjacent proximity electrode signals using triangulation methods; and step 112, displaying each feature on the virtual keyboard at correct X-Y location and using depth cues corresponding to Z position.

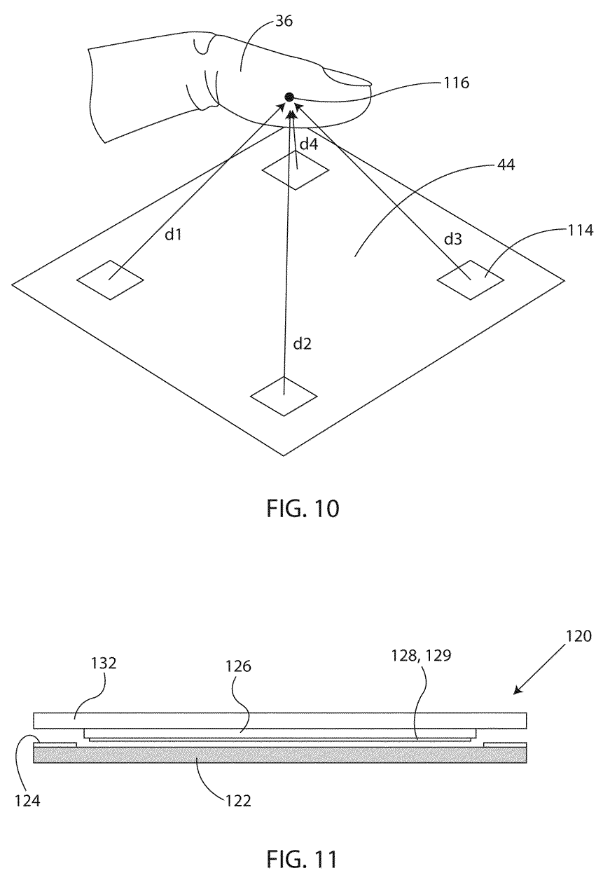

Referring now to FIG. 10, the triangulation of a target 36 using a plurality of proximity sensors 114 is known in the art. Such processes are used for GPS location of objects to calculate a position based detections from several distant satellites. In the figure, location of a target 36 using four proximity sensors 114 is depicted. The target 36 is measured as being a distance of d1, d2, d3 and d4 from the corresponding sensors 114.

In order to perform tracking as herein described, a triangulation algorithm is solved based on the corresponding inputs d1 to d4, thus locating the point 116 of the target in 3D space.

Referring to FIG. 11, in another embodiment, the PDID 20, 20′ uses a multiple 3D proximity sensing module 120. The module 120 is made up of a PCB 122, proximity sensors 124, a touchpad module 126 having ITO dual layers or a regular touchpad PCB, and a glass panel 132. The PCB 122 has integrated thereon, several proximity sensors 124 arranged in a cluster or an array (which cluster can take the form of a rectangle surrounding the touchpad module 126, described below). On top of the PCB 122 with integrated proximity sensors (or antennae) 124, is a touchpad module 126 itself made up of a touchpad PCB 128. Alternatively, an ITO (Indium Tin Oxide) dual layer 129 may be used. A glass panel is then placed thereon, to seal the assembly within the housing (not shown). In this way, the assembly is able to measure proximity of the target by calculating the 3D position of the target based on the detected distances of the array of sensors (e.g., as illustrated in FIG. 10 above).

Other embodiments capable of tracking a target 36 as it approaches a touch surface 40, 44, 74 use known technology for in tracking moving objects of differing sizes ranging from that of a hockey puck to an airplane. Essentially, these known technologies use proximity sensors in the form of radars which measure distance between the sensor and the target. Where a sufficient number of sensors are used in a cluster, the distance information transmitted can be resolved, using an algorithm running on a processor, to a single target or a minimum set of possible targets. Such suitable tracking technologies are described in U.S. Pat. No. 6,304,665, to Cavallaro et al, U.S. Pat. No. 5,509,650 to MacDonald, WO2005/077466 to Bickert et al, U.S. Pat. No. 5,138,322 to Nuttall, and U.S. Pat. No. 6,292,130 to Cavallaro et al, the contents of which are incorporated herein by reference thereto. The components described therein need only be miniaturized and adapted for use in tracking targets as they approach a touch surface or keyboard.

In a further embodiment, movement detection technology in video images, such as that described in U.S. Pat. No. 6,760,061, to Nestor, Inc, the content of which is incorporated by reference, may be used to recognize an object by tracking changes in luminescence in defined tiles across the video image taken of the user's hand above the input device, whereas selection of particular keys is sensed by traditional capacitive touch sensors. Consequently, a single video camera 138 embedded in the PDID 20″ can sense the position and movement of targets 36 above the PDID which, together with a processor 12 and instructions 26′ operating thereon, are first inverted (e.g., step 154 of the method 140 below described in connection with FIG. 12) and processed before projection for optimal, rapid display, preferably in transparent mode over the virtual keyboard 33 on the display 16. A pattern recognition step or steps (e.g., steps 144 and/or 146 of the method 140 below described in connection with FIG. 12) may be performed in which a user's hand is recognized according to the shape viewed and classified as a hand in which a particular finger is likely to be closest the keyboard or touch interface 40, 44, 45 (after comparison with stored shapes of hands representative of hands having a particular extended finger for example). Such particular finger may then be associated with the closest sensed object to the capacitive sensors and so this portion of the sensed hand is registered to the closest finger location, thereby allowing an accurate overlay of the hand image 32 on the virtual input area 33. In such a case, the transparent image 32 used for the target 36 may be an actual video image of the target captured by the video camera 138.

Referring to FIG. 12, in more detail, the method 140 for recognizing and projecting video images 32 of a target 36 includes several steps. In a first step 142, the target 36 is videoed as it approaches the input field 40, 44, 45, 74. In a second step 144, the target 36 is recognized using pattern recognition software and classify by type. In a third step 146, using pattern recognition software, the image is compared with a library of patterns for such target type and the type identified (together with associated subpatterns). In a fourth step 150, using proximity sensors 54, 62, 114, 124, the portion of the target 36 closest to input device surface 40, 44, 45, 74 is located. In a fifth step 152, the portion of the target 36 recognized as most proximate to input surface 40, 44, 45, 74 is registered to the location associated with the portion (e.g. 116 of FIG. 10) of the target 36 detected by proximity sensors 54, 62, 114, 124 to be closest to input surface 40, 44, 45, 74. In a sixth step 154, the video image is inverted as necessary to accommodate a differing viewpoint from the user. In a seventh step, the video image of the target is overlaid in proper registration to input field, preferably in transparent mode.

In another embodiment, the processor 12 includes instructions in an instruction set for automatic system activation when the proximity sensor 54, 62, 114, 124 detects a target 36 in appropriate proximity to the PDID 20, 20′. Upon automatic system activation, a representation 32 of the target 36 is displayed on the display 16. Further, optionally, upon automatic system activation, a representation 33 of the input field 40, 44 is displayed on the display 16. Sensing of proximity of a target 36 to the PDID 20, 20′ triggers the display of a virtual representation 33 of at least the input field 40, 44, 45 of the PDID on the display 16. Where the proximity sensor 54, 62, 114, 124 remains active even in sleep mode, such sensing can be used to power up the PDID 20, 20′, or to activate otherwise power consuming functionality (such as an illumination feature, a backlighting module or a local display), in a system ready mode. Further, when a user 34 sees his virtual finger 32 appear on the display 16, then he can adjust the position of his virtual finger relative to the virtual input field 33 without ever having to glance at the physical PDID 20, 20′ or his own finger.

In another embodiment suitable for allowing a presenter to virtually gesticulate before an audience with his hands or arms, the proximity sensing subsystem 54 detects multiple targets 36 and transmits relative location data dynamically, in real time to the OS 24 of the PC 14, for display of multiple fingers of one or more hands over the virtual PDID 33, so as to further allow a user to focus their eyes only on the display 16 in order to better understand and correct his or her finger motions so as to improve his or her input throughput into the system of the invention. This ability of focusing only on the computer display should reduce eye fatigue usually caused by having to glance at the physical input device and then refocus on the more distant computer display. In addition, such an embodiment overlays the detected hands or arms on the display 16 which although physically distant from the user 34, is nonetheless the focus of the audience's attention, thereby facilitating communication for such presentations.

In another embodiment, the system 10 and method 30, 140 of the invention permits sizing, relocation and hiding of the virtual representation 33 of the PDID 20, 20′ on the display 16 in a conventional manner, such as clicking to close, resize or move a window.

In another embodiment, the virtual representation 32 of the target 36 is displayed on the display 16 in a 2D plan view using various cues such as distance/depth cue such as: variation of the target size, variation of the target color and/or transparency, variation of the target shadow relative position, variation of the target shadow color and/or transparency, variation of the target shadow blur and displaying arrows encoding the distance between the target and the touch input device surface. Sound may also be used, where the sound varies as the target approaches or retreats from the PDID 20, 20′.

Such virtual representation 32 of the target 36 may be a simple abstraction thereof, such as a mouse cursor but may also be any other shape such as a simplified representation of a human finger. A suitable virtual representation 32 of a human finger may be an elongated rectangle (not shown), with a rounded or pointed input end, which, for simplicity is projected on the display 16 in a vertical orientation. In such an embodiment, the relative location of end of the rectangle corresponding to the input end of the target is of importance. The opposite end is presented for visual comprehension only (i.e., that such representation is that of a finger).

Referring now to FIG. 13, the system 10 may be embodied in an input device 20″ having a single, multiple or an array of pressure activated keys 160 (prior art keys such as dome switch keys or scissor keys) in which an optical proximity sensor 162 (for example, an infrared sensor) is integrated in the center of at least one key thereof, or in selected keys. A round, transparent cover 164 seals the proximity sensor 162 in the key 160. A data connection device (such as DCD 58 of FIG. 5) is provided to transmit signals from the proximity sensor 162 that correspond to input and/or proximity data to a processor 12. The proximity sensor 162, preferably an infrared sensor in this embodiment, is adapted to dynamically recognize the movement of a target 36 in the proximity of the input device 20″. An instruction set is executable by the processor 12 when input and/or proximity data (including presence, distance and optionally trajectory data, i.e., 3D data vector data) of the proximity sensor 160 are received via the data connection device of the input device 20″ by the processor 12. The proximity sensor 160 is adapted to determine the presence of a target 36 as well as an approximate distance of the target to the key 160, and, optionally the trajectory thereof. The processor 12 constructs a representation 33 of input fields 40, 44, 45 for display in a window of the display 16. The processor 12 further constructs and overlays a real-time, virtual representation 32 of the target 36 over such constructed representation. The proximity sensor 160 therefore enhances a standard, pressure activated key by detecting when a target 36 is near thereto or approaches it. This therefore allows coordination of interactions of a user to be made by reference to the displayed virtual representations.

In another embodiment, instead of an infrared proximity sensor 160, the input device having a single, multiple or an array of pressure activated keys 160 (prior art keys such as dome switch keys or scissor keys) has a capacitive sensor 62, 114, 124 integrated therein, preferably underneath each key. In this embodiment, no transparent cover is required because the capacitive sensor will essentially see through the key and be able to detect an approaching target as if the key itself were not there (i.e., the key is transparent to the sensor).

In still another embodiment, instead of using proximity sensors, a pressure sensing touch surface, such as the multitouch input surface available from Stantum S.A. of France, allows the simulation of finger “hovering” over the surface by equating the “hovering” action as hereinbefore described, to the sliding of a user's finger over the touch surface using a light pressure below a certain threshold. Pressure exerted by the user's finger above a certain threshold of pressure is equated to touch and so the input associated with the touch location is registered. This embodiment allows for a low cost version of the invention, which in most other ways, allows for a user experience that is as described in the other embodiments mentioned herein.

In a feature of the invention, a user experience is created of using a touch screen display device remotely from such device, without requiring that the user touch the display and further not requiring a touch screen display device.

In another feature of the invention, the invention allows the creation of a one to one copy of the real world in the virtual world, providing a user with flexibility of location, relative orientation, etc that the virtual world provides (e.g., allowing typing while reclining in a comfortable chair while watching information on a TV type large display screen in a living room type scenario, while standing and working at a distance from a large screen, while presenting information on a large screen to others or collaborating in real time with others while interacting with a computing device having a large screen display).

In another feature, the invention allows a user to input data into a virtual keyboard remotely from a displayed virtual representation of the keyboard.

In another feature, the invention permits a user more comfort and flexibility in interacting with a PC or personal entertainment device, such as a multimedia player.

The invention is intended to comprise a system or method substantially as hereinbefore described having reference to the accompanying drawings.

Moreover, the system and method of the invention contemplates the use, sale and/or distribution of any goods, services or information having similar functionality described herein.

The mentioning of a supplier herein of a system or element adaptable for use in the invention should not be taken as an admission that the cited technology antedates the invention of the instant invention, but rather as an indication of a source of a suitable component, the knowledge of which may have been gained after the priority date claimed for the instant invention. In other words, the citation of a suitable component herein should not be taken as an admission that such is prior art to the instant invention.

The specification and figures are to be considered in an illustrative manner, rather than a restrictive one and all modifications described herein are intended to be included within the scope of the invention claimed, even if such is not specifically claimed at the filing of the application. For example, use of the term “virtual keyboard” should be construed as encompassing any input field or array or cluster of input fields such as icons, menus, or drop down menus displayed on a display for virtual interaction with a target. Accordingly, the scope of the invention should be determined by the claims appended hereto or later amended or added, and their legal equivalents rather than by merely the examples described above. For instance, steps recited in any method or process claims may be executed in any order and are not limited to the specific order presented in any claim. Further, the elements and/or components recited in any apparatus claims may be assembled or otherwise operationally configured in a variety of permutations to produce substantially the same result as the present invention. Consequently, the invention is not limited to the specific configuration recited in the claims and may be augmented, for example, by features disclosed in U.S. Provisional Application No. 61/314,639, filed 17 Mar. 2010, the content of which is incorporated herein by reference thereto.

Benefits, other advantages and solutions mentioned herein are not to be construed as critical, required or essential features or components of any or all the claims.

As used herein, the terms “comprises”, “comprising”, or any variation thereof, are intended to refer to a non-exclusive listing of elements, such that any process, method, article, composition or apparatus of the invention that comprises a list of elements does not include only those elements recited, but may also include other elements described in this specification. The use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or otherwise adapted by the skilled artisan to other design without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Multiple variations and modifications are possible in the embodiments of the invention described here. Although certain illustrative embodiments of the invention have been shown and described here, a wide range of modifications, changes, and substitutions is contemplated in the foregoing disclosure. While the above description contains many specifics, these should not be construed as limitations on the scope of the invention, but rather as exemplifications of one or another preferred embodiment thereof. In some instances, some features of the present invention may be employed without a corresponding use of the other features. Accordingly, it is appropriate that the foregoing description be construed broadly and understood as being given by way of illustration and example only, the spirit and scope of the invention being limited only by the claims which ultimately issue in this application.

### ELEMENT LIST

### FIGS. 1-3

System 10
Processor 12
PC, set-top box, multimedia device 14
Display 16
Input device, PDID 20 (entire keyboard)
Wireless hub 22
Operating system 24
Instructions 26
Method 30
Representation of target 32
Representation of input field 33
User 34
Target 36
Thumbs 37
Principal input device 38

### FIG. 4

Principal input surface 40
Keying input field 42
Multi-touch input surface, touch surface 44
Housing 46
Auxiliary input device 48
Infrared sensor 162
Single multi-touch surface 45
Grid 50
Zones 52

### FIG. 5

Proximity Sensing Subsystem (PSS) 54
Transceiver 56
Data connection device (DCD) 58

### FIG. 6

Touchpad module 60
Proximity sensors 62
Surface of touchpad module 64
PCB 66
Array of proximity sensors 68
Thin backlight 70
Glass panel 72
Upper surface 74 of glass panel

### FIG. 7A

Circle 75
Grid 76
Distance d

### FIG. 7B

Filled circles 80
Grid 76′
Key 82

### FIG. 8

Table 90

### FIG. 9

Method 30
Step one 100
Step two 102
Step three 104
Step four 106
Step five 110
Step six 112

### FIG. 10

Sensors 114
d1
d2
d3
d4

### FIG. 11

3D proximity sensing module 120
PCB 122
Proximity electrodes 124
Touchpad module 126
Touchpad PCB 128
ITO dual layer 129
Glass panel 132

### FIG. 12

Video Camera 138
Method 140
Step one 142
Step two 144
Step three 146
Step four 150
Step five 152
Step six 154

### FIG. 13

Input device 20″
Key 160
Proximity sensor 162
Round cover 164

What is claimed is:

1. A peripheral device for enabling virtual input on a remote display, the peripheral device comprising:
(a) at least one proximity sensor adapted to dynamically recognize the movement of at least one target in the proximity of the peripheral device; and
(b) a data connection device adapted to transmit signals from the proximity sensor to a processor communicatively coupled to the remote display and to cooperate therewith so as to construct:
(i) a representation of input fields on the display, and
(ii) when detected, overlay a real-time, virtual representation of the target over the representation of the input fields.

2. The peripheral device of claim 1, wherein the target is one of a group of targets consisting of a user's hand or hands, finger or fingers, arm or arms, a stylus or styluses, and a pointer or pointers.

3. The peripheral device of claim 1, wherein the at least one proximity sensor is integrated into at least one traditional mechanical key, thereby providing touch activation of keys when a prescribed touch parameter is met.

4. The peripheral device of claim 3, wherein the touch parameter is a parameter of sufficient proximity, at which proximity a touch signal indicating touch is sent to the processor, thereby allowing traditional keypad use with the benefits of touch pad use.

5. The peripheral device of claim 1, wherein the proximity sensor is selected from a group of proximity sensors consisting of capacitive, infrared, electromagnetic, read switch, hall effect, resistive variation, conductive variation, echo, radio waves, heat detection, eddy currents, optical pattern recognition technologies and micro air flux change.

6. The peripheral device of claim 1, further comprising at least one touch sensor.

7. The peripheral device of claim 1, further comprising a multi-touch input surface.

8. The peripheral device of claim 2, wherein the multi-touch input surface is integrated onto a housing which is separable from a principle input surface permitting keying.

9. The peripheral device of claim 1, where the representation of the input fields for display in a window of a display is a representation of a virtual keyboard.

10. The peripheral device of claim 1, wherein the representation of input fields for display in a window of the display is transparent, permitting viewing of screen content visually underneath the representation of the input fields.

11. The peripheral device of claim 1 wherein the processor includes instructions in an instruction set for automatic system activation when the proximity sensor detects a target in appropriate proximity to the peripheral device.

12. The peripheral device of claim 11, wherein, upon automatic system activation, a representation of the target is displayed on the display.

13. The peripheral device of claim 11, wherein, upon automatic system activation, a representation of the input fields is displayed on the display.

14. The peripheral device of claim 1, where the representation of the target of claim 1 is presented using a depth cue selected from a group of depth cues consisting of:
variation of target size;
variation of target color and/or transparency;
variation of target shadow relative position;
variation of target shadow color and/or transparency;
variation of target shadow blur;
displaying arrows encoding the distance between the target and the input device surface; and
by a sound cue or a variation in sound emitted by an associated sound system as the target approaches or retreats from the input device surface.

15. The peripheral device of claim 1, wherein the virtual representation of the target is a simplified representation in which only an input end of the target is displayed oriented accurately with respect to the representation of the input fields.

16. The peripheral device of claim 14, wherein the end of the target opposite to the input end is presented in a simplified manner.

17. A system is provided for reproducing and displaying on a display the input relationship of a target, thereby allowing coordination of interactions of a user to be made by reference to the displayed virtual representations, the system including:
a. an input device; and
b. an instruction set executable by the processor wherein, when input and/or proximity data are received from the input device by the processor, the processor constructs a representation of input fields for display in a window of the display, wherein further, the processor constructs and overlays a real-time, virtual representation of a target detected by the input device over such constructed representation.

18. The system of claim 17, wherein the input device includes:
a. at least one pressure activated input key;
b. at least one proximity sensor adapted to dynamically recognize the movement of a target in the proximity of the input device; and
c. data connection device adapted to transmit signals corresponding to input and/or proximity data to a processor

19. A method is provided for providing touch screen-like input functionality to a display remotely from the display, the method including the steps of:
a. detecting proximity of one or more targets to a remote input device;
b. processing on a processor the 3D location of the one or more targets using the proximity data;
c. displaying a virtual representation of an input area on the display connected to the processor;
d. calculating relative position and transmitting such relative position information to the processor; and;
e. displaying a virtual representation of the one or more targets dynamically, in real time, oriented with respect to the virtual touch screen input device as such one or more targets are detected in relation to the physical input device.

20. An input key having integrated therein at least one proximity sensor adapted to determine the presence of a target as well as an approximate distance of the target to the key, the sensor connectable to a processor for processing the presence and distance information.

21. The input key of claim 20, wherein the proximity sensor is adapted to measure and communicate the trajectory of a target.

22. The input key of claim 20, wherein the proximity sensor is selected from a group of proximity sensors consisting of capacitive, infrared, electromagnetic, reed switch, Hall effect, resistive variation, conductive variation, echo, radio waves, heat detection, eddy currents, optical pattern recognition technologies and micro air flux change.

23. The input key of claim 22, wherein the key is a dome switch key.

24. The input key of claim 22, wherein the key is a scissor key.

25. A peripheral device for enabling virtual input on a remote display, the peripheral device comprising:
at least one proximity sensor adapted to dynamically recognize the movement of at least one target in the proximity of the peripheral device;
a data connection device adapted to transmit signals from the proximity sensor to a processor communicatively coupled to the remote display, and
encoded instructions for, when a target is detected, overlaying a real-time, virtual representation of the target on the remote display in an orientation which represents the real world orientation of the target to the proximity sensor.

26. A method is provided for providing touch screen-like input functionality to a display remotely from the display in which inputs are made to a remote peripheral device, the method including the steps of:
a. reading proximity signals from each proximity sensing electrode;
b. checking if proximity signals are above a feature detection threshold and, if so classifying them as high proximity signals;
c. classifying high proximity signals into clusters based on corresponding sensing electrode locations which indicate a single feature detection;
d. identifying the local highest proximity signal, for each cluster; and
e. calculating the XYZ position of each feature by processing each local highest proximity signal with adjacent proximity electrode signals using triangulation methods; and
f. displaying each feature on the virtual keyboard at correct X-Y location and using depth cues corresponding to Z position.

27. The method of claim 26, wherein the peripheral device includes at least one integrated video camera, and wherein the method includes the following supplemental steps:
a. categorizing the target with the aid of integrated video camera;
b. identifying an area of the target which is likely to coincide with the detected local highest proximity signal;
c. registering the area of the target likely to coincide with the detected local highest proximity signal; and
d. displaying the image of the target in register to a representation of the input area of the peripheral device, preferably in transparent mode.

28. A peripheral device for enabling virtual input on a remote display, the peripheral device comprising:
at least one proximity sensor adapted to dynamically recognize the movement of at least one target in the proximity of the peripheral device;
a data connection device adapted to transmit signals from the proximity sensor to a processor communicatively coupled to the remote display, and
encoded instructions for, when executed on the processor, causing data read from a detected target and transmitted by the data connection device to be processed so as to overlay a virtual representation of the target on the remote display in real-time, in an orientation which represents the real world orientation of the target to the proximity sensor.

29. (canceled)

30. (canceled)
